(19) United States
(12) Patent Application Publication
(10) Pub. No.: US 2006/0200055 A1
(43) Pub. Date: Sep. 7, 2006

(54) Unitary irrigating pocket probe

(76) Inventor: Gary J. Pond, Racine, WI (US)

Correspondence Address: RYAN KROMHOLZ & MANION, S.C., POST OFFICE BOX 26618, MILWAUKEE, WI, 53226, US

(21) Appl. No.: 11/073,914

(22) Filed: Mar. 7, 2005

(51) Int. Cl. A61H 13/00; A61C 17/00

(52) U.S. Cl. 601/163; 601/139; 433/80; 433/88

(57) ABSTRACT

A unitary, one-piece dental irrigation tip for delivering fluids from a dental device to a dental site. The tip has a proximal end having releasable locking means for attachment to the device, and a distal end providing an opening for fluid delivery to the dental site.

### BACKGROUND OF THE INVENTION

The present invention relates to dental instruments and, more specifically, to dental tips used for dental irrigation and delivery of dental fluids to dental pockets within a mouth cavity.

Current dentistry practices have focused on making dental procedures more comfortable for the patient. For instance, dental tips have been designed to take into account the soft tissue of the gum/tooth area of a person's mouth and design the dental tip to be easily inserted within a cavity or canal.

Dental tips have been designed to provide a flexible end tip that may conform along the shape of a dental cavity, such as a periodontal pocket. Such a design has the benefit of being more comfortable for the patient. An example of such a dental tip is Bab, U.S. Pat. No. 5,127,831. The dental tip in Bab comprises two sections: a rigid arm section and a flexible tip section. The flexible tip section is fixedly secured to the rigid arm section. While this dental tip has been used to ease dental procedures, the two-section design has some shortcomings. For instance, the process of fixing the two pieces together may be time consuming and difficult. Also, because two distinct pieces are being fixed together, the fluid passageway of the dental tip may become obstructed, especially where the two sections are fixed together. Likewise, when the dental tip is inserted into a dental area or pocket, the flexible tip section has a tendency to crimp or bend along the area where the flexible tip is adjoined to the rigid arm. This can result in lower productivity from specific tips and can result in increased costs, as nonfunctioning tips will have to be discarded. Further, crimped or bent dental tips can cause problems in delivering fluid to a dental site.

### SUMMARY OF THE INVENTION

The present invention comprises a one-piece, unitary dental tip for delivering a fluid from a dental fluid delivery device to a gingival pocket, canal or cavity located within a person's mouth. The dental tip has a proximal end that will be connected to the dental device and a distal end that provides means for delivering a fluid to a dental site. An insert molding process, which allows for the dental tip to be designed as a unitary, one-piece dental tip, can be used to design the dental tip.

### BRIEF DESCRIPTION OF THE DRAWINGS

FIG. 1 is a side plan view of a prior art dental tip.

FIG. 2 is a front perspective view of a dental tip in accordance with the present invention.

FIG. 3 is a close-up view of a distal end of the dental tip shown in FIG. 2.

FIG. 4 is a rear perspective view of a dental tip in accordance with the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

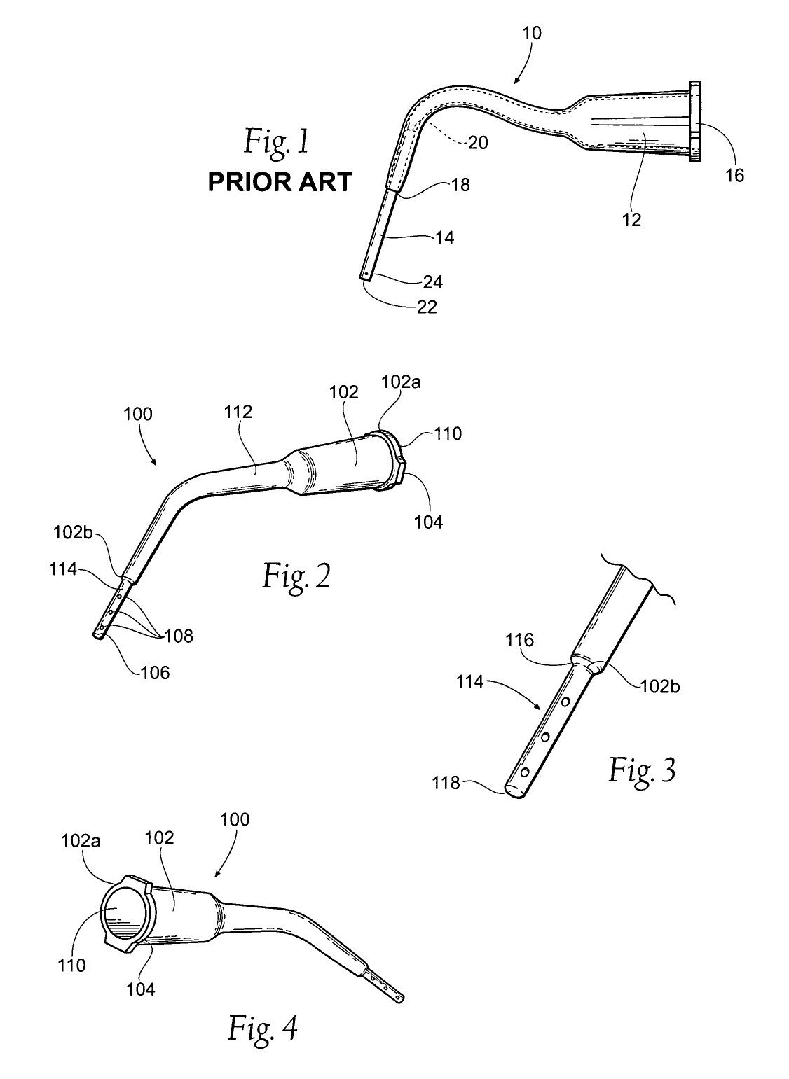

FIG. 1 shows a prior art dental tip 10. The dental tip 10 is comprised of two separate sections: A rigid arm 12 and a flexible distal conduit 14. The rigid arm 12 has a connection hub 16 at one end and an opening 18 at the opposing end. The flexible distal conduit 14 has a first end 20 and a second end 22. The first end 20 is inserted into the opening 18 and secured and fixed to the rigid arm 12. The distal conduit 14 also has an exit 24 located near the second end 22 for delivery of fluids to a dental site. As shown, the first end 20 must be inserted into the opening 18 sufficiently far enough to insure that the arm 12 and the distal conduit 14 will be secured together. Consequently, if the distal conduit 14 is inserted to far into the arm 12, the distal conduit 14 can prohibit or block fluid flow, which can make the needle inefficient or unusable. Furthermore, when the distal conduit 14 is fixed to the rigid arm 12, the securing process or adhesive may potentially fuse together the two sections, or close up the passageway, which makes the tip 10 inoperable. Likewise, the distal conduit 14 has a tendency to crimp or fold where it is inserted into the opening 18, when the dental tip 10 is inserted into a dental cavity, thereby preventing fluid flow through the dental tip 10.

FIG. 2 shows a perspective view of a dental tip 100 according to the present invention. The dental tip 100 has a proximal section 102 having a first end 102a and a second end 102b. Locking means 104 are located on the first end 102a, which allow the dental tip 100 to be secured to a dental device (not shown). A distal section 106 is integrally formed with the proximal section 102 and the distal section 106 comprises at least one fluid exit 108. A fluid passageway 110 extends from the first end 102a of the proximal section 102 to the fluid exit 108. The dental tip 100 is designed and formed integrally as a single, unitary piece, which provides for the fluid passageway 110 to act as a continuous, uninhibited flow path. Since the proximal section 102 and the distal section 104 are formed as a single piece, the fluid passageway 110 will not be impeded by any fastening means that were previously required for securing individual sections of a dental tip together, thereby alleviating the potential prior art problems discussed above.

Still referring to FIG. 2, the proximal section 102 generally comprises a rigid base or arm section 112, and the distal section generally comprises a flexible end section 114. By varying the wall thickness in sections 102, 112, and 114, varying degrees of flexibility can be achieved. While the sections 112 and 114 are described as individual sections, they are nonetheless formed as a single, unitary dental tip 100. The fluid passageway 110 is larger in diameter within the proximal section 102 and narrower in diameter within the flexible end section 114. The dental tip 100 may also be designed so that the fluid passageway 110 evenly inwardly tapers within the flexible section 114. While it is possible to design the dental tip with a fluid passageway 110 having a constant diameter throughout the length of the fluid passageway, the design allows attachment to standard dental devices and, also, allows comfortable insertion of the dental tip 100 into an interdental space or gum-tooth pocket.

FIG. 3 shows a close-up view of the flexible end section 114. The end section 114 has a first end 116 and a second end 118. The first end 116 is integral with the second end 102b of the proximal section 102. Since the end section 114 and the arm section 112 will be formed from as a single, unitary design, the end section may be considered as an integral extension of the base section 112. While, the diameter of the first end 116 may vary, the diameter preferably is designed to minimize or eliminate any possible crimping or bending of the flexible end section 114 when inserted into a dental cavity, while still allowing the end section 114 to retain flexible properties.

Still referring to FIG. 3, the second end 118 preferably has a blunt design, with the fluid exits 108 located along the body of the flexible section 114. While it is possible to have the exits 108 located on the second end 118, the shown arrangement is preferred since it is more comfortable for the patient. However, it is understood that the location of the fluid exits 108 may be rearranged and the dental tip 100 would still fall within the scope of the present invention. Likewise, the number of exits 108 located on the flexible section 114 may vary and still fall within the scope of the present invention.

FIG. 4 is a rear perspective view of the dental tip 100 and the first end 102a of the proximal section 102. The locking means 104 is depicted as being a LUER-LOK®-style locking means, which is the preferred style of locking device known and used in the art. However, it is understood that any locking means 104 that will secure the dental tip 100 to a dental instrument (not shown) will fall within the scope of the present invention. As previously discussed the fluid passageway 110 has a larger diameter at the proximal section 102 than it does at the distal section 106, including the flexible section 114. Thus, the dental tip 100 will properly attach to common dental instruments at the base section 112, while allowing the flexible section 114 to be easily inserted within a patient's periodontal cavity or similar area within the mouth region.

As noted above, the dental tip 100 is formed as a single, unitary piece. A molding process preferably accomplishes the formation of the dental tip. One such process for forming the dental tip 100 is an insert molding process. Insert molding is performed by injecting a polymer around a core material, which could be another polymer, a ceramic perform or a metal component. The process was not previously used for forming dental tips, since the proper molds and designs had not been contemplated or realized for the formation of the current style of dental tips. The advantages of the one-piece, unitary construction had not been fully understood. As a result, dental tips were previously formed as two-piece designs having the shortcomings of the prior art discussed above.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A unitary, one-piece dental irrigation tip for delivering fluids from a dental tool to a dental site, said tip comprising:
a proximal section, said proximal section providing releasable locking means to said dental tool;
a distal section, said distal section providing at least one opening for fluid delivery;
a fluid passageway passing from said proximal section to said at least one opening; and
said proximal section and said distal section being of unitary, one-piece construction.

2. The dental irrigation tip according to claim 1 wherein said distal end has a first end and a second end, said first end being integrally formed with said proximal section, said second end being closed, said opening being located between said first end and said second end.

3. The dental irrigation tip according to claim 3 further comprising a plurality of openings, said openings being located between said first end and said second end, said fluid passageway passing from said proximal section to said plurality of openings.

4. The dental irrigation tip according to claim 1 wherein said distal section is flexible.

5. A unitary, one-piece irrigation dental tip for delivering fluids from a dental tool to a dental area, said dental tip formed by an insert molding process, said dental tip comprising:
a proximal section, said proximal section providing releasable locking means to said dental tool;
a distal section, said distal section providing at least one opening for fluid delivery;
a fluid passageway passing from said proximal section to said at least one opening; and
said proximal section and said distal section being of unitary, one-piece construction.

6. The dental irrigation tip according to claim 5 wherein said distal end has a first end and a second end, said first end being integrally formed with said proximal section, said second end being closed, said opening being located between said first end and said second end.

7. The dental irrigation tip according to claim 6 further comprising a plurality of openings, said openings being located between said first end and said second end, said fluid passageway extending from said proximal section to said plurality of openings.

8. The dental irrigation tip according to claim 6 wherein said distal section is flexible.

9. The dental irrigation tip according to claim 8 wherein said proximal section is substantially rigid.
